(19) United States
(12) Patent Application Publication
(10) Pub. No.: US 2024/0262745 A1
(43) Pub. Date: Aug. 8, 2024

(54) Gypsum Panel Having Reduced Calcination

(71) Applicant: Gold Bond Building Products, LLC, Charlotte, NC (US)

(72) Inventors: Ratnasabapathy Gurunathan Iyer, Charlotte, NC (US); Eli Stav, Charlotte, NC (US); Joseph J. Bailey, Charlotte, NC (US)

(21) Appl. No.: 18/429,568

(22) Filed: Feb. 1, 2024

Related U.S. Application Data
(60) Provisional application No. 63/483,129, filed on Feb. 3, 2023.

(51) Int. Cl. C04B 11/02; C04B 28/14; C04B 111/00

(52) U.S. Cl. CPC C04B 11/022; C04B 28/14; C04B 2111/00405; C04B 2111/0062

(57) ABSTRACT

The present invention is directed to a gypsum panel with reduced calcination and a method of making such gypsum panel. For instance, in one embodiment, the gypsum panel comprises a gypsum core and a first facing material and a second facing material sandwiching the gypsum core, wherein the gypsum core includes gypsum and a calcination inhibitor. The methods of the present invention are directed to making the aforementioned gypsum panels.

### RELATED APPLICATIONS

The present application is based on and claims priority to U.S. Provisional Patent Application Ser. No. 63/483,129, having a filing date of Feb. 3, 2023, which is incorporated herein by reference in its entirety.

### BACKGROUND OF THE INVENTION

Gypsum panels are commonly employed in drywall construction of interior walls and ceilings and also have other applications. Generally, these gypsum panels are formed from a gypsum slurry including a mixture of calcined gypsum (i.e., stucco), water, and other conventional additives. The mixture is cast and allowed to set by reaction of the stucco with the water. During the production of the gypsum panel, the gypsum panel undergoes a drying process. However, the drying process can revert the gypsum formed by the reaction of the stucco and the water back into calcium sulfate hemihydrate. The reversion of the gypsum back into calcium sulfate hemihydrate may be referred to as calcination or surface calcination. Calcination of the gypsum panel may lead to poor gypsum core to facing material bond and/or may decrease the strength of the gypsum panel.

As a result, there is a need to provide an improved gypsum panel that has reduced calcination.

### SUMMARY OF THE INVENTION

Aspects and advantages of the invention will be set forth in part in the following description, or may be obvious from the description, or may be learned through practice of the invention.

In accordance with one embodiment of the present invention, a gypsum panel is disclosed. The gypsum panel comprises a gypsum core, the gypsum core comprising gypsum and a calcination inhibitor, the gypsum core having a concentration gradient of the calcination inhibitor over a thickness of the gypsum core, the calcination inhibitor being present in the gypsum panel in an amount from about 0.001 wt. % to about 5 wt. % based on the weight of the gypsum core; and a first facing material and a second facing material, the first facing material and the second facing material sandwiching the gypsum core.

In accordance with another embodiment of the present invention, a gypsum panel is disclosed. The gypsum panel comprises a gypsum core, the gypsum core comprising gypsum and a calcination inhibitor, the calcination inhibitor being present in the gypsum panel in an amount from about 0.001 wt. % to about 5 wt. % based on the weight of the gypsum core; and a first facing material and a second facing material, the first facing material and the second facing material sandwiching the gypsum core. The ratio of the concentration of the calcination inhibitor at the interface of the gypsum core and the first facing material to the concentration of the calcination inhibitor at the center of the thickness of the gypsum core is more than 1:1.

In accordance with yet another embodiment of the present invention, a method of making a gypsum panel is disclosed. The method comprises: providing a first facing material; depositing a gypsum slurry comprising stucco, water, and a calcination inhibitor onto the first facing material; providing a second facing material on the gypsum slurry; and allowing the stucco to convert to calcium sulfate dihydrate.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a gypsum panel and a method of making such gypsum panel. In particular, the gypsum panel can include a gypsum core including a calcination inhibitor as defined herein. In this regard, the gypsum core may include gypsum (i.e., calcium sulfate dihydrate), a calcination inhibitor, and may include other optional additives. The present inventors have discovered that the gypsum panel disclosed herein can have various benefits due to the use of a calcination inhibitor. For instance, the present inventors have discovered that the mechanical properties and characteristics of the gypsum panel may be improved. For instance, the gypsum panel disclosed herein may have increased nail pull resistance, increased panel strength, and enhanced bonding between the gypsum core and the respective facing materials.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. It should be understood that any concentration values disclosed herein may refer to mass concentration, molar concentration, number concentration, or volume concentration.

In general, the gypsum core may comprise calcium sulfate dihydrate. The gypsum may be from a natural source, a synthetic source, and/or reclaim and is thus not necessarily limited by the present invention. In general, the gypsum, in particular the calcium sulfate dihydrate, is present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum is present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In addition, the gypsum core may comprise a calcination inhibitor. In general, a calcination inhibitor may be incorporated into a gypsum panel and/or any component thereof at any point of the process disclosed herein, including during, before, and/or after any of the process steps disclosed herein. The calcination inhibitor may reduce or prevent the calcination of a gypsum panel during the drying process of the gypsum panel. Particularly, the calcination inhibitor may reduce or prevent calcination at the interface of the gypsum core and the first facing material and/or the second facing material. It should be understood that the gypsum core disclosed herein may comprise more than one calcination inhibitor. For instance, the gypsum core disclosed herein may comprise two calcination inhibitors or three calcination inhibitors. The one or more calcination inhibitors may be selectively chosen to form a combination of calcination inhibitors that synergistically interact to reduce the calcination of a gypsum panel. In some aspects, the calcination inhibitor may enhance the antifungal and/or antimicrobial properties of a gypsum panel. In this respect, the calcination inhibitor may prevent or reduce fungal and/or microbial growth in a gypsum panel when compared to a gypsum panel not containing the calcination inhibitor.

The calcination inhibitor of the present disclosure may include an amide (e.g., a primary amide, a secondary amide, a tertiary amide, or a combination thereof). For instance, the calcination inhibitor may include urea, which generally has the chemical formula CO(NH₂)₂. In another aspect, the calcination inhibitor may include urea-formaldehyde. Generally, traditional gypsum panels utilize glycerin or sugar (e.g., dextrose) to reduce the calcination of the gypsum panel. However, in some instances, glycerin or sugar may support fungal and/or microbial growth in a gypsum panel. Notably, in some aspects, a gypsum panel formed in accordance with the present disclosure may be substantially free or completely free of additives such as glycerin and/or sugar. As used herein, a gypsum panel “substantially free” of glycerin and/or sugar has a glycerin and/or sugar content of less than about 0.05% by weight of the gypsum panel, such as less than about 0.01% by weight of the gypsum panel, such as less than about 0.005% by weight of the gypsum panel.

The gypsum panel of the present disclosure may comprise a calcination inhibitor in various forms. For instance, the calcination inhibitor may be processed such that the calcination inhibitor is prilled, granulated (e.g., fine granulated particles, coarse granulated particles), in solution, or a combination thereof. Generally, a prilled calcination inhibitor may dissolve in water more rapidly than a granulated calcination inhibitor. Additionally, in some aspects, a prilled calcination inhibitor may have a more narrow particle size distribution when compared to a granulated calcination inhibitor. In this respect, the range of particle sizes of a prilled calcination inhibitor may be less than the range of particle sizes of a granulated calcination inhibitor.

Generally, the calcination inhibitor may have a nitrogen content of from about 10 wt. % to about 70 wt. %, including all increments of 0.1 wt. % therebetween. For instance, the calcination inhibitor may have a nitrogen content of about 10 wt. % or more, such as about 20 wt. % or more, such as about 30 wt. % or more, such as about 40 wt. % or more, such as about 50 wt. % or more, such as about 60 wt. % or more, such as about 70 wt. % or less, such as about 60 wt. % or less, such as about 50 wt. % or less, such as about 40 wt. % or less, such as about 30 wt. % or less, such as about 20 wt. % or less.

In general, the calcination inhibitor may have a formaldehyde content of from about 0 wt. % to about 10 wt. %, including all increments of 0.1 wt. % therebetween. For instance, the calcination inhibitor may have a formaldehyde content of about 0 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 2 wt. % or more, such as about 5 wt. % or more. Generally, the calcination inhibitor may have a formaldehyde content of about 10 wt. % or less, such as about 8 wt. % or less, such as about 5 wt. % or less, such as about 2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less. In some aspects, the calcination inhibitor may be substantially free of formaldehyde. As used herein, a calcination inhibitor “substantially free” of formaldehyde has a formaldehyde content of less than about 2 wt. %, such as about 1 wt. % or less, such as about 0.5 wt. % or less, such as about 0.1 wt. % or less.

In some aspects, the calcination inhibitor may have a biuret content of from about 0 wt. % to about 10 wt. %, including all increments of 0.1 wt. % therebetween. For instance, the calcination inhibitor may have a biuret content of about 0 wt. % or more, such as about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 2 wt. % or more, such as about 5 wt. % or more. Generally, the calcination inhibitor may have a biuret content of about 10 wt. % or less, such as about 8 wt. % or less, such as about 5 wt. % or less, such as about 2 wt. % or less, such as about 1 wt. % or less, such as about 0.9 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less, such as about 0.1 wt. % or less, such as about 0.05 wt. % or less. In some aspects, the calcination inhibitor may be substantially free of biuret. As used herein, a calcination inhibitor “substantially free” of biuret has a biuret content of less than about 2 wt. %, such as about 1 wt. % or less, such as about 0.5 wt. % or less, such as about 0.1 wt. % or less.

Generally, the calcination inhibitor may have a bulk density of from about 500 kg/m³ to about 1000 kg/m³, including all increments of 1 kg/m³ therebetween. For instance, the calcination inhibitor may have a bulk density of about 500 kg/m3 or more, such as about 600 kg/m³ or more, such as about 700 kg/m³ or more, such as about 800 kg/m³ or more, such as about 900 kg/m³ or more. Generally, the calcination inhibitor may have a bulk density of about 1000 kg/m³ or less, such as about 900 kg/m³ or less, such as about 800 kg/m³ or less, such as about 700 kg/m³ or less, such as about 600 kg/m³ or less.

In order to provide the desired effect, the calcination inhibitor may have a selectively chosen average particle size. For instance, the calcination inhibitor may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less. In general, the calcination inhibitor may have an average particle size of 20 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of the calcination inhibitor. In this respect, the calcination inhibitor may have a D₁₀, D₅₀, D₉₀, or D₉₈ of any of the values previously disclosed, including any incremental values therebetween.

Generally, the calcination inhibitor may have a selectively chosen particle size distribution. The particle size distribution of the calcination inhibitor may be monomodal, bi-modal, or multi-modal. The one or more modes may fall within any of the particle size values, including any ranges thereof, disclosed herein. In some aspects, a US standard mesh size of 4 (i.e., 4.75 mm) to 50 (i.e., 0.3 mm) may retain from 0 wt. % to about 100 wt. % of the calcination inhibitor, including all increments of 0.01 wt. % therebetween. In some aspects, a US standard mesh size of 6 may retain about 10 wt. % to about 30 wt. % of the calcination inhibitor, such as about 10 wt. % or more, such as about 15 wt. % or more, such as about 20 wt. % or more, such as about 25 wt. % or more, such as about 30 wt. % or less, such as about 25 wt. % or less, such as about 20 wt. % or less, such as about 15 wt. % or less. In some aspects, a US standard mesh size of 7 may retain about 50 wt. % to about 85 wt. % of the calcination inhibitor, such as about 50 wt. % or more, such as about 60 wt. % or more, such as about 70 wt. % or more, such as about 80 wt. % or more, such as about 85 wt. % or less, such as about 80 wt. % or less, such as about 70 wt. % or less, such as about 60 wt. % or less. In some aspects, a US standard mesh size of 10 may retain about 90 wt. % to about 100 wt. % of the calcination inhibitor, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, a US standard mesh size of 18 may retain about 90 wt. % to about 100 wt. % of the calcination inhibitor, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. In some aspects, a US standard mesh size of 30 may retain about 90 wt. % to about 100 wt. % of the calcination inhibitor, such as about 90 wt. % or more, such as about 95 wt. % or more, such as about 98 wt. % or more, such as about 99 wt. % or more, such as about 99.9 wt. % or more, such as about 100 wt. % or less, such as about 99.9 wt. % or less, such as about 99 wt. % or less, such as about 98 wt. % or less. Notably, in some aspects, any and/or all of the aforementioned percentage values may be based on volume percent.

In some aspects, the calcination inhibitor may reduce the calcination of a gypsum panel by about 5% to about 95%, including all increments of 0.01% therebetween. The calcination of a gypsum panel may be determined, at least in part, by the weight percent of calcium sulfate hemihydrate. The calcination of a gypsum panel may be determined by X-ray diffraction (XRD) analysis, such as with a PANalytical X'Pert Pro or Olympus BTX diffractometer, of a sample of the gypsum core or respective gypsum core layer scraped from a portion of a respective facing material adjacent the gypsum core or respective gypsum core layer. In this respect, when a respective facing material is removed from the gypsum core, the side of the facing material that was previously adjacent the gypsum core may be scraped to obtain a sample of the gypsum core or respective gypsum core layer. The reduction in calcination may be determined by the difference in the calcium sulfate hemihydrate content between a control gypsum panel that does not contain a calcination inhibitor and another, different gypsum panel that is identical to the control gypsum panel except that the gypsum panel contains a calcination inhibitor.

In general, the calcination inhibitor may reduce the calcination of a gypsum panel by about 5% or more, such as about 10% or more, such as about 20% or more, such as about 30% or more, such as about 40% or more, such as about 50% or more, such as about 60% or more, such as about 70% or more, such as about 80% or more, such as about 90% or more. Generally, the calcination inhibitor may reduce the calcination of a gypsum panel by about 95% or less, such as about 90% or less, such as about 80% or less, such as about 70% or less, such as about 60% or less, such as about 50% or less, such as about 40% or less, such as about 30% or less, such as about 20% or less, such as about 10% or less. For instance, in one aspect, if a control gypsum panel has a calcination of about 5 wt. % (i.e., a calcium sulfate hemihydrate content of about 5 wt. %) after the drying process, the inclusion of the calcination inhibitor in an identically formed gypsum panel may reduce the calcination by about 76%, resulting in a gypsum panel having a calcination of about 1.2 wt. % (i.e., a calcium sulfate hemihydrate content of about 1.2 wt. %) after the drying process.

In some aspects, a gypsum panel formed in accordance with the present disclosure may have a calcium sulfate hemihydrate content of about 0.01 wt. % to about 10 wt. %, such as about 0.01 wt. % or more, such as about 0.05 wt. % or more, such as about 0.1 wt. % or more, such as about 0.2 wt. % or more, such as about 0.5 wt. % or more, such as about 0.8 wt. % or more, such as about 0.9 wt. % or more, such as about 1 wt. % or more, such as about 1.2 wt. % or more, such as about 1.5 wt. % or more, such as about 2 wt. % or more, such as about 3 wt. % or more, such as about 4 wt. % or more, such as about 5 wt. % or more. Generally, the calcium sulfate hemihydrate content of the gypsum panel may be less than about 10 wt. %, such as about 8 wt. % or less, such as about 5 wt. % or less, such as about 4 wt. % or less, such as about 3 wt. % or less, such as about 2 wt. % or less, such as about 1.5 wt. % or less, such as about 1 wt. % or less, such as about 0.9 wt. % or less, such as about 0.8 wt. % or less, such as about 0.5 wt. % or less, such as about 0.2 wt. % or less, such as about 0.1 wt. % or less. The calcium sulfate hemihydrate content of a gypsum panel may be determined by X-ray diffraction (XRD) analysis, such as with a PANalytical X'Pert Pro or Olympus BTX diffractometer, of a sample of the gypsum core or respective gypsum core layer scraped from a portion of a respective facing material adjacent the gypsum core or respective gypsum core layer.

Generally, a gypsum panel formed in accordance with the present disclosure may have a calcium sulfate dihydrate content of about 70 wt. % to about 98 wt. %, such as about 70 wt. % or more, such as about 75 wt. % or more, such as about 80 wt. % or more, such as about 85 wt. % or more, such as about 87 wt. % or more, such as about 90 wt. % or more, such as about 92 wt. % or more, such as about 95 wt. % or more. Generally, the calcium sulfate dihydrate content of the gypsum panel is less than about 98 wt. %, such as about 95 wt. % or less, such as about 92 wt. % or less, such as about 90 wt. % or less, such as about 87 wt. % or less, such as about 85 wt. % or less, such as about 80 wt. % or less, such as about 75 wt. % or less. The calcium sulfate dihydrate content of a gypsum panel may be determined by X-ray diffraction (XRD) analysis, such as with a PANalytical X'Pert Pro or Olympus BTX diffractometer, of a sample of the gypsum core or respective gypsum core layer scraped from a portion of a respective facing material adjacent the gypsum core or respective gypsum core layer.

Generally, a calcination inhibitor may be present in any element of the disclosed gypsum panel. For instance, a calcination inhibitor may be present in and/or on one or more of the facing materials of the gypsum panel. Additionally or alternatively, for instance, a calcination inhibitor may be present in the gypsum slurry or the gypsum core of the gypsum panel. Further, for instance, a calcination inhibitor may be present in one or more gypsum core layers (e.g., first gypsum core layer, second gypsum core layer, third gypsum core layer) of the gypsum panel. Additionally, for instance, a calcination inhibitor may be present in one or more gypsum slurries (e.g., first gypsum slurry, second gypsum slurry, third gypsum slurry) utilized to form a gypsum core and/or one or more gypsum core layers of a gypsum panel.

Generally, the calcination inhibitor may be present in the gypsum panel in an amount of 0.001 lbs/MSF to 50 lbs/MSF, including all increments of 0.001 lbs/MSF therebetween. For instance, the calcination inhibitor may be present in the gypsum panel in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 10 lbs/MSF or more, such as 20 lbs/MSF or more, such as 30 lbs/MSF or more, such as 40 lbs/MSF or more. Generally, the calcination inhibitor may be present in the gypsum panel in an amount of 50 lbs/MSF or less, such as 40 lbs/MSF or less, such as 30 lbs/MSF or less, such as 20 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

Further, in some aspects, a calcination inhibitor may be present in a gypsum panel and/or any component thereof in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.35 wt. % or more, such as 0.4 wt. % or more, such as 0.45 wt. % or more, such as 0.5 wt. % or more, such as 0.6 wt. % or more, such as 0.7 wt. % or more, such as 0.8 wt. % or more, such as 0.9 wt. % or more, such as 1 wt. % or more, such as 1.2 wt. % or more, such as 1.5 wt. % or more, such as 2 wt. % or more, such as 3 wt. % or more, such as 4 wt. % or more. In some aspects, the calcination inhibitor may be present in a gypsum panel and/or any component thereof in an amount of 5 wt. % or less, such as 4 wt. % or less, such as 3 wt. % or less, such as 2 wt. % or less, such as 1.8 wt. % or less, such as 1.5 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.45 wt. % or less, such as 0.4 wt. % or less, such as 0.35 wt. % or less, such as 0.30 wt. % or less, such as 0.25 wt. % or less, such as 0.2 wt. % or less, such as 0.15 wt. % or less, such as 0.1 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

It should be understood that the calcination inhibitor may be calcined or uncalcined. In one aspect, a gypsum panel formed in accordance with the present disclosure may be free or substantially free of triethanolamine. As used herein, “substantially free” means that the gypsum panel has a triethanolamine content of about 2 wt. % or less, such as about 1 wt. % or less, such as about 0.5 wt. % or less, such as about 0.1 wt. % or less, such as about 0.05 wt. % or less.

In general, the concentration of a calcination inhibitor may be higher in the area of the gypsum core near a respective facing material and may decrease across at least a portion of the thickness of the gypsum core. In one aspect, any of the respective gypsum core layers (e.g., first gypsum core layer, second gypsum core layer, third gypsum core layer) may have a higher concentration of the calcination inhibitor than the other gypsum core layers. For instance, in one aspect, the first gypsum core layer and/or third gypsum core layer may have a higher concentration of a calcination inhibitor than the second gypsum core layer. In some aspects, one or more gypsum core layers may be free of a calcination inhibitor.

Generally, the calcination inhibitor may be heterogeneously or nonuniformly dispersed in the gypsum core. In one aspect, the concentration of the calcination inhibitor may be such that a concentration gradient of the calcination inhibitor is formed in a gypsum core. In some aspects, the concentration gradient may be such that the concentration of the calcination inhibitor increases or decreases over a portion of the thickness, such as a thickness disclosed herein, of a gypsum core formed in accordance with the present disclosure. In one aspect, a gypsum core formed in accordance with the present disclosure may have a higher concentration of the calcination inhibitor in the portion of the gypsum core adjacent to the first facing material (e.g., the first gypsum core layer) with the concentration of the calcination inhibitor decreasing across a dimension (e.g., a thickness) of the gypsum core. In general, in one aspect, the concentration of the calcination inhibitor in the gypsum core may decrease across a thickness of a gypsum core beginning at the portion of the gypsum core adjacent the first facing material and ending at the portion of the gypsum core adjacent the second facing material.

In one aspect, a gypsum core (e.g., set gypsum core) formed in accordance with the present disclosure may have a higher concentration of the calcination inhibitor in the portion of the gypsum core adjacent to the second facing material (e.g., the third gypsum core layer) with the concentration of the calcination inhibitor decreasing across a dimension (e.g., a thickness) of the gypsum core. As used herein, a “set gypsum core” refers to the gypsum core after the drying process of the gypsum panel, which may include drying the gypsum panel in a heating or drying device (e.g., kiln). In general, in one aspect, the concentration of the calcination inhibitor in the gypsum core may decrease across the thickness of a gypsum core beginning at the portion of the gypsum core adjacent the second facing material and ending at the portion of the gypsum core adjacent the first facing material.

Notably, the concentration of the calcination inhibitor in the gypsum core (e.g., set gypsum core) may be higher in the portions of the gypsum core adjacent to the respective facing materials (e.g., the first gypsum core layer and the third gypsum core layer). For instance, the concentration of the calcination inhibitor in the gypsum core may be higher in the portions of the gypsum core adjacent the first facing material and the second facing material, as compared to the concentration at the center of the thickness of the gypsum core. It should be understood that the center of the thickness of the gypsum core is parallel to one or more respective facing materials and is a plane that extends the length and width of the gypsum core. In one aspect, a gypsum core formed in accordance with the present disclosure may have a higher concentration of the calcination inhibitor adjacent to the first facing material and the second facing material with the concentration of the calcination inhibitor decreasing toward the center of the thickness of the gypsum core beginning at the portions of the gypsum core adjacent the first facing material and second facing material respectively.

Notably, in one aspect, the three highest concentrations of the calcination inhibitor in a gypsum core (e.g., set gypsum core) may be at the portion of the gypsum core adjacent the first facing material, at the center of the thickness of the gypsum core, and at the portion of the gypsum core adjacent the second facing material respectively. In this respect, the area of a gypsum core between the portion of the gypsum core adjacent the first facing material and the center of the thickness of the gypsum core may have a reduced concentration of the calcination inhibitor compared to the concentration of the calcination inhibitor in the portion of the gypsum core adjacent the first facing material and the center of the thickness of the gypsum core. Further, the area of a gypsum core between the portion of the gypsum core adjacent the second facing material and the center of the thickness of the gypsum core may have a reduced concentration of the calcination inhibitor compared to the concentration of the calcination inhibitor in the portion of the gypsum core adjacent the second facing material and the center of the thickness of the gypsum core.

In one aspect, a gypsum core (e.g., set gypsum core) formed in accordance with the present disclosure may have a higher concentration of the calcination inhibitor in the portion of the gypsum core adjacent to the first facing material as compared to the concentration of the calcination inhibitor in the portion of the gypsum core adjacent to the second facing material. In this respect, the concentration of the calcination inhibitor in the portion of the gypsum core adjacent to the first facing material may be higher than the concentration of the calcination inhibitor in the portion of the gypsum core adjacent to the second facing material. In another aspect, a gypsum core (e.g., set gypsum core) formed in accordance with the present disclosure may have a higher concentration of the calcination inhibitor in the portion of the gypsum core adjacent to the second facing material as compared to the concentration of the calcination inhibitor in the portion of the gypsum core adjacent to the first facing material. In this respect, the concentration of the calcination inhibitor in the portion of the gypsum core adjacent to the second facing material may be higher than the concentration of the calcination inhibitor in the portion of the gypsum core adjacent to the first facing material.

It should be understood that the portion of the gypsum core adjacent to the first facing material may be referred to as the first gypsum core layer. Additionally, when the gypsum core includes two gypsum core layers, the portion of the gypsum core adjacent to the second facing material may be referred to as the second gypsum core layer. Further, when the gypsum core includes three gypsum core layers, the portion of the gypsum core adjacent to the second facing material may be referred to as the third gypsum core layer.

In one aspect, the concentration of the calcination inhibitor in the gypsum core or a portion of the gypsum core (e.g., first gypsum core layer, second gypsum core layer, third gypsum core layer, an interface of the gypsum core and one or more facing materials) may be from about 0 ppm to about 2000 ppm, such as about 0 ppm or more, such as about 50 ppm or more, such as about 100 ppm or more, such as about 200 ppm or more, such as about 500 ppm or more, such as about 1000 ppm or more, such as about 1500 ppm or more, such as about 2000 ppm or less, such as about 1500 ppm or less, such as about 1000 ppm or less, such as about 500 ppm or less, such as about 200 ppm or less, such as about 100 ppm or less, such as about 50 ppm or less. It should be noted that, in some aspects, the concentration of the calcination inhibitor in the gypsum core or a portion of the gypsum core may be greater than 2000 ppm. Notably, in some aspects, the concentration of the calcination inhibitor may be highest at the interface of the gypsum core and a facing material, such as the interface of the gypsum core and the first facing material or such as the interface of the gypsum core and the second facing material.

In one aspect, the ratio of the concentration of the calcination inhibitor at the interface of the gypsum core and a facing material (e.g., the first facing material, the second facing material) to the concentration of the calcination inhibitor at the center of the thickness of the gypsum core may be from about 20:1 to about 1:20, including all incremental ratios therebetween. For instance, the ratio of the concentration of the calcination inhibitor at the interface of the gypsum core and a facing material (e.g., the first facing material, the second facing material) to the concentration of the calcination inhibitor at the center of the thickness of the gypsum core may be 20:1 or less, such as about 15:1 or less, such as about 10:1 or less, such as about 5:1 or less, such as about 1:1 or less, such as about 1:5 or less, such as about 1:10 or less, such as about 1:15 or less. In general, the ratio of the concentration of the calcination inhibitor at the interface of the gypsum core and a facing material (e.g., the first facing material, the second facing material) to the concentration of the calcination inhibitor at the center of the thickness of the gypsum core may be about 1:20 or more, such as about 1:15 or more, such as about 1:10 or more, such as about 1:5 or more, such as about 1:1 or more, such as about 5:1 or more, such as about 10:1 or more, such as about 15:1 or more. In another aspect, the aforementioned ratios may refer to the weight ratio of the weight of the calcination inhibitor at the interface of the gypsum core and a facing material (e.g., the first facing material, the second facing material) to the weight of the calcination inhibitor at the center of the thickness of the gypsum core.

In general, the composition of the gypsum core is not necessarily limited and may include any additives as known in the art. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants, fillers (e.g., glass spheres, glass fibers), natural and synthetic fibers (e.g. cellulosic fibers, microfibrillated fibers, nanocellulosic fibers, etc.), waxes (e.g., silicones, siloxanes, etc.), acids (e.g., boric acid), secondary phosphates (e.g., condensed phosphates or orthophosphates including trimetaphosphates, polyphosphates, and/or cyclophosphates, etc.), mixtures thereof, natural and synthetic polymers, starches, sound dampening polymers (e.g., viscoelastic polymers/glues, such as those including an acrylic/acrylate polymer, etc.; polymers with low glass transition temperature, etc.), etc., and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

As indicated herein, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, the present invention is also directed to a method of making a gypsum panel. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, at least one gypsum slurry includes a calcination inhibitor. In this regard, the method may include a step of also combining a calcination inhibitor with the stucco, water, and any optional additives as indicated herein.

In general, stucco may be referred to as calcined gypsum or calcium sulfate hemihydrate. The calcined gypsum may be from a natural source or a synthetic source and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may also include water. Water may be employed for fluidity and also for rehydration of the gypsum to allow for setting. The amount of water utilized is not necessarily limited by the present invention.

The weight ratio of the water to the stucco may be 0.1 or more, such as 0.2 or more, such as 0.2 or more, such as 0.3 or more, such as 0.4 or more, such as 0.5 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses and other fibers (e.g. cellulosic fibers, microfibrillated fibers, nanocellulosic fibers, etc.), high molecular weight polymers, etc.), leveling agents, non-leveling agents, starches (such as pregelatinized starch, non-pregelatinized starch, and/or an acid modified starch), colorants, fire retardants or additives (e.g., silica, silicates, expandable materials such as vermiculite, perlite, etc.), water repellants, fillers (e.g., glass fibers), waxes (e.g., silicones, siloxanes, etc.), secondary phosphates (e.g., condensed phosphates or orthophosphates including trimetaphosphates, polyphosphates, and/or cyclophosphates, etc.), sound dampening polymers (e.g., viscoelastic polymers/glues, such as those including an acrylic/acrylate polymer, etc.; polymers with low glass transition temperature, etc.), mixtures thereof, natural and synthetic polymers, etc. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In an additional embodiment, the aforementioned weight percentages may be based on the weight of the gypsum in the respective facing material. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in one aspect, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 90 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In one aspect, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In one aspect, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in one aspect, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In one aspect, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include at least one dispersant. The dispersant is not necessarily limited and may include any that can be utilized within the gypsum slurry. The dispersant may include carboxylates, sulfates, sulfonates, phosphates, mixtures thereof, etc. For instance, in one embodiment, the dispersant may include a sulfonate.

In another embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In one aspect, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In one aspect, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less.

As indicated above, the additives may include a starch. The starch may be one generally utilized in the art. Such starch may be combined with the stucco and water. In this regard, such starch may be present in the gypsum slurry as well as the resulting gypsum core and gypsum panel.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively higher gelling temperature. Meanwhile, without intending to be limited by theory, modifications of the hydroxyl group, such as by replacement via ethoxylation, ethylation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In one aspect, the starch may be provided in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

The manner in which the components (e.g., stucco, water, calcination inhibitor) for the gypsum slurry are combined is not necessarily limited. For instance, the gypsum slurry can be made using any method or device generally known in the art. In particular, the components of the slurry can be mixed or combined using any method or device generally known in the art. For instance, the components of the gypsum slurry may be combined in any type of device, such as a mixer and in particular a pin mixer. In this regard, the manner in which the components are incorporated into the gypsum slurry is not necessarily limited by the present invention. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soap may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry. In addition, whether providing the components prior to or after the mixing device or directly into the mixing device, the compound may be delivered as a solid, as a dispersion/solution, or a combination thereof. Notably, in one aspect, a calcination inhibitor and stucco may be mixed and ball-milled together before being contacted with water to form a gypsum slurry. Further, in another aspect, a calcination inhibitor and gypsum may be mixed and ball-milled together before being incorporated into the gypsum slurry.

Upon deposition of the gypsum slurry, the calcium sulfate hemihydrate reacts with the water to hydrate the calcium sulfate hemihydrate into a matrix of calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for drying of the gypsum slurry, in particular drying any free water instead of combined water of the gypsum slurry. Such drying may occur prior to the removal of any free moisture or water in a heating or drying device after a cutting step. Thereafter, the method may also comprise a step of cutting a continuous gypsum sheet into a gypsum panel. Then, after the cutting step, the method may comprise a step of supplying the gypsum panel to a heating or drying device to undergo a drying process. For instance, such a heating or drying device may be a kiln and may allow for removal of any free water. The temperature and time required for drying in a heating device is not necessarily limited by the present invention.

In another embodiment, the calcination inhibitor may be applied during the gypsum board manufacturing process. In this regard, it may be applied in lieu of providing and combining with the gypsum in forming the gypsum slurry or in addition to providing and combining with the gypsum in forming the gypsum slurry. Generally, the method of application of the calcination inhibitor is not limited by the present disclosure and may include any method of application known in the art. Notably, the calcination inhibitor may be applied to the first facing material, the gypsum slurry, the second facing material, or a combination thereof. In one aspect, the calcination inhibitor may be applied by spraying, brushing, curtain coating, or roll coating. In one aspect, the calcination inhibitor may be applied to the second facing material. For instance, the calcination inhibitor may be applied to at least a portion of the side of the second facing material that is adjacent the gypsum slurry (i.e., the gypsum slurry facing side of the second facing material) before the second facing material is provided on the gypsum slurry. In this respect, the calcination inhibitor may not be applied to the gypsum slurry but may instead be applied to the second facing material before the second facing material is provided or placed on the gypsum slurry. Further, in another aspect, the calcination inhibitor may be applied to the gypsum slurry before the second facing material is provided or placed on the gypsum slurry. In this respect, the calcination inhibitor may be applied to at least a portion of the gypsum slurry adjacent the second facing material before the second facing material is provided or placed on the gypsum slurry. Additionally, in yet another aspect, the calcination inhibitor may be applied to the gypsum slurry before the second facing material is provided or placed on the gypsum slurry and may be applied to at least a portion of the side of the second facing material that is adjacent the gypsum slurry (i.e., the gypsum slurry facing side of the second facing material) before the second facing material is provided on the gypsum slurry.

In one aspect, the calcination inhibitor may be applied to the first facing material. In this respect, in one aspect, the calcination inhibitor may be applied to at least a portion of the side of the first facing material that is adjacent the gypsum slurry before the gypsum slurry is deposited onto the first facing material.

Notably, the calcination inhibitor may be applied to one or more facing materials on a surface or side of a facing material (e.g., first facing material, second facing material) opposite a gypsum slurry and/or gypsum core. In this respect, the calcination inhibitor may be applied to one or more facing materials on the outward facing surface of one or more facing materials.

In general, the calcination inhibitor may be incorporated in and/or applied to one or more facing materials (e.g., first facing material, second facing material) during the manufacturing process of the gypsum panel and/or in an offline process. When incorporated and/or applied in an offline process, the calcination inhibitor may be applied to a facing material (e.g., first facing material, second facing material) before the facing material is utilized in the manufacturing process of the gypsum panel.

Generally, the calcination inhibitor may be present at the interface of the gypsum slurry or gypsum core and the first facing material and/or may be present at the interface of the gypsum slurry or gypsum core and the second facing material.

In one embodiment, the gypsum core may include a first gypsum core layer and a second gypsum core layer. The first gypsum core layer may be between the first facing material (e.g., front of the gypsum panel) and the second gypsum core layer. In addition, the first gypsum core layer may have a density greater than the second gypsum core layer. Accordingly, the first gypsum core layer may be formed using a gypsum slurry without the use of foam and/or a foaming agent or with a reduced amount of foam and/or a foaming agent, which may be utilized in forming the second gypsum core layer. In this regard, in one embodiment, the first gypsum core layer may have the same composition as the second gypsum core layer except that the second gypsum core layer may be formed using foam and/or a foaming agent or a greater amount of foam and/or a foaming agent.

In one embodiment, the gypsum core may also include a third gypsum core layer. The third gypsum core layer may be provided between the second gypsum core layer and a second facing material (e.g., back of the gypsum panel). Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of foam and/or a foaming agent or with a reduced amount of foam and/or a foaming agent, which may be utilized in forming the second gypsum core layer. In this regard, in one embodiment, the third gypsum core layer may have the same composition as the second gypsum core layer except that the second gypsum core layer may be formed using foam and/or a foaming agent or a greater amount of foam and/or a foaming agent.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include foam and/or a foaming agent or more foam and/or a foaming agent than the first gypsum slurry. In this regard, in one embodiment, the first gypsum slurry may not include foam and/or a foaming agent. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include foam and/or a foaming agent or more foam and/or a foaming agent than the third gypsum slurry. In this regard, in one embodiment, the third gypsum slurry may not include foam and/or a foaming agent. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

Various gypsum core layers may be a particularly suitable location for a calcination inhibitor. When included in a gypsum core layer, a calcination inhibitor may reduce the calcination of the respective gypsum core layer. In some aspects, as previously disclosed herein, the gypsum panel may include a first gypsum core layer, a second gypsum core layer, and a third gypsum core layer. In one aspect, having an amount of a calcination inhibitor present in the first gypsum core layer and/or the third gypsum core layer may have enhanced efficacy in reducing or preventing calcination when compared to a gypsum panel having a similar amount of a calcination inhibitor present in the second gypsum core layer. Such enhanced efficacy may be a result of the concentration of the calcination inhibitor present in the first gypsum core layer and/or the third gypsum core layer, which may be more than the concentration of the calcination inhibitor present in the second gypsum core layer. Furthermore, having a calcination inhibitor in a respective gypsum core layer may reduce the amount of calcination inhibitor present in another, different gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Generally, the first gypsum core layer, the second gypsum core layer, and/or the third gypsum core layer may contain any of the additives as disclosed herein, such as a calcination inhibitor. Further, the first gypsum core layer, the second gypsum core layer, and/or the third gypsum core layer may contain an additive in an amount as previously indicated herein.

As indicated herein, the gypsum core can include a calcination inhibitor. In this regard, in one embodiment, the first gypsum core layer may include a calcination inhibitor disclosed herein. In another embodiment, the second gypsum core layer may include a calcination inhibitor as disclosed herein. In a further embodiment, the third gypsum core layer may include a calcination inhibitor as disclosed herein. In an even further embodiment, the first gypsum core layer and the second gypsum core layer may include a calcination inhibitor as disclosed herein. In another further embodiment, the first gypsum core layer, the second gypsum core layer, and the third gypsum core layer may include a calcination inhibitor as disclosed herein. In yet another embodiment, a calcination inhibitor may be included adjacent to the first facing material and/or the second facing material.

Regardless of the above, a calcination inhibitor may be present in any combination of gypsum core layers. However, in one embodiment, it should be understood that one or two of the aforementioned gypsum core layers may not include a calcination inhibitor. In one aspect, one or more gypsum core layers may comprise the same calcination inhibitor. Further, in one aspect, the one or more gypsum core layers may comprise different calcination inhibitors. The different calcination inhibitors of the one or more gypsum core layers may be chosen such that it is advantageous to have a particular calcination inhibitor in one gypsum core layer and a different calcination inhibitor in another, different gypsum core layer.

The gypsum panel disclosed herein may have many applications. For instance, the gypsum panel may be used as a standalone panel in construction for the preparation of walls, ceilings, floors, roofs, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 90 microns to about 1200 microns, such as about 90 microns or more, such as about 100 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more, such as about 600 microns or more, such as about 700 microns or more, such as about 800 microns or more. Generally, the average void size may be about 1200 microns or less, such as about 1100 microns or less, such as about 1000 microns or less, such as about 900 microns or less, such as about 800 microns or less, such as about 700 microns or less, such as about 600 microns or less, such as about 500 microns or less, such as about 400 microns or less, such as about 300 microns or less, such as about 200 microns or less, such as about 100 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 15 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more, such as 5 m²/g or more, such as 6 m²/g or more, such as 8 m²/g or more, such as 10 m²/g or more. The specific surface area of the gypsum core may be 15 m²/g or less, such as 10 m²/g or less, such as 8 m²/g or less, such as 6 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present invention is not necessarily limited by the aforementioned thicknesses.

In addition, the panel weight of the gypsum panel is not necessarily limited. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 lb_{f} or less, such as about 140 lb_{f} or less, such as about 130 lb_{f} or less, such as about 120 lb_{f} or less, such as about 110 lb_{f} or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### EXAMPLES

### Example 1

Gypsum panels were made which included no calcination inhibitor, urea, and dextrose respectively. All of the gypsum panels were the same except for the exclusion or addition of a calcination inhibitor. Sample 1, which is the control sample, did not contain a calcination inhibitor. Sample 2 contained urea in an amount of 0.35 wt. % based on the weight of stucco in the gypsum slurry. Sample 3 contained dextrose in an amount of 0.35 wt. % based on the weight of stucco in the gypsum slurry. An X-ray diffraction analysis was performed on each of the respective samples with a PANalytical X'Pert Pro diffractometer. The respective samples of the gypsum core were scraped from the side of the respective facing material previously adjacent the gypsum core after the respective facing material was removed from the gypsum core. Table 1 illustrates the results of the X-ray diffraction analysis on the respective samples. The text below the respective sample number of the “Sample” column is a description of the respective sample. For instance, “Control—Front” indicates that the sample is from the control gypsum panel and that the sample was taken from the side of the first facing material that was previously adjacent the gypsum core after the first facing material was removed from the gypsum core. Further, for instance, “Control—Back” indicates that the sample is from a control gypsum panel and that the sample was taken from the side of the second facing material that was previously adjacent the gypsum core after the second facing material was removed from the gypsum core.

TABLE 1

| | Calcium Sulfate | Calcium Sulfate |
|---|---|---|
| | Dihydrate | Hemihydrate |
| Sample | [wt. %] | [wt. %] |
| Sample 1 | 90.7 | 4.8 |
| (Control - Front) | | |
| Sample 1 | 90.5 | 5.0 |
| (Control - Back) | | |
| Sample 2 | 91.7 | 0.9 |
| (Urea - Front) | | |
| Sample 2 | 91.1 | 1.2 |
| (Urea - Back) | | |
| Sample 3 | 90.1 | 0.5 |
| (Dextrose - Front) | | |
| Sample 3 | 87.1 | 3.3 |
| (Dextrose - Back) | | |

### Example 2

A gypsum panel was made which included stucco, water, and urea. The gypsum panel contained urea in an amount of 0.35 wt. % based on the weight of stucco in the gypsum slurry. The concentration of urea at the interface of the gypsum core and the first facing material was measured and the concentration of urea at the center of the thickness of the gypsum core was measured.

TABLE 2

| Urea Concentration at | Urea Concentration at |
|---|---|
| Gypsum Core and First | Center of Thickness of |
| Facing Material Interface | Gypsum Core |
| [ppm] | [ppm] |
| 900 | 75 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A gypsum panel comprising:
a gypsum core, the gypsum core comprising gypsum and a calcination inhibitor, the gypsum core having a concentration gradient of the calcination inhibitor over a thickness of the gypsum core, the calcination inhibitor being present in the gypsum panel in an amount from about 0.001 wt. % to about 5 wt. % based on the weight of the gypsum core; and
a first facing material and a second facing material, the first facing material and the second facing material sandwiching the gypsum core.

2. The gypsum panel of claim 1, wherein the calcination inhibitor comprises an amide.

3. The gypsum panel of claim 2, wherein the amide is urea.

4. The gypsum panel of claim 1, wherein the calcination inhibitor has an average particle size from about 50 microns to about 5 mm.

5. The gypsum panel of claim 1, wherein the calcination inhibitor has an average particle size from about 500 microns to about 5 mm.

6. The gypsum panel of claim 1, wherein the calcination inhibitor has an average particle size from about 600 microns to about 4 mm.

7. The gypsum panel of claim 1, wherein the calcination inhibitor is present in the gypsum panel in an amount from about 0.01 wt. % to about 2 wt. % based on the weight of the gypsum core.

8. The gypsum panel of claim 1, wherein the calcination inhibitor is present in the gypsum panel in an amount from about 0.1 wt. % to about 1 wt. % based on the weight of the gypsum core.

9. The gypsum panel of claim 1, wherein the calcination inhibitor has a nitrogen content from about 30 wt. % to about 60 wt. %.

10. The gypsum panel of claim 1, wherein the calcination inhibitor has a formaldehyde content from 0 wt. % to about 10 wt. %.

11. The gypsum panel of claim 1, wherein the calcination inhibitor has a formaldehyde content from 0 wt. % to about 5 wt. %.

12. The gypsum panel of claim 1, wherein the calcination inhibitor is substantially free of formaldehyde.

13. The gypsum panel of claim 1, wherein the calcination inhibitor has a biuret content from 0 wt. % to about 10 wt. %.

14. The gypsum panel of claim 1, wherein the calcination inhibitor has a biuret content from 0 wt. % to about 5 wt. %.

15. The gypsum panel of claim 1, wherein the calcination inhibitor is substantially free of biuret.

16. The gypsum panel of claim 1, wherein the calcium sulfate dihydrate content of the gypsum panel is from about 70 wt. % to about 98 wt. % as determined by X-ray diffraction analysis.

17. The gypsum panel of claim 1, wherein the calcium sulfate hemihydrate content of the gypsum panel is from 0 wt. % to about 10 wt. % as determined by X-ray diffraction analysis.

18. The gypsum panel of claim 1, wherein the calcination inhibitor is present in the gypsum panel in an amount from about 0.001 lbs/MSF to 50 lbs/MSF.

19. The gypsum panel of claim 1, wherein the gypsum core comprises at least two gypsum core layers, wherein only one gypsum core layer comprises the calcination inhibitor.

20. The gypsum panel of claim 1, wherein the calcination inhibitor has antimicrobial properties.

21. A gypsum panel comprising:
a gypsum core, the gypsum core comprising gypsum and a calcination inhibitor, the calcination inhibitor being present in the gypsum panel in an amount from about 0.001 wt. % to about 5 wt. % based on the weight of the gypsum core; and
a first facing material and a second facing material, the first facing material and the second facing material sandwiching the gypsum core;
wherein the ratio of the concentration of the calcination inhibitor at the interface of the gypsum core and the first facing material to the concentration of the calcination inhibitor at the center of the thickness of the gypsum core is more than 1:1.

22. A method for making the gypsum panel of claim 1 comprising:
providing a first facing material;
depositing a gypsum slurry comprising stucco, water, and a calcination inhibitor onto the first facing material,
providing a second facing material on the gypsum slurry; and
allowing the stucco to convert to calcium sulfate dihydrate.
